(19) United States
(12) Patent Application Publication
(10) Pub. No.: US 2006/0206406 A1
(43) Pub. Date: Sep. 14, 2006

(54) Program-based supply chain management

(76) Inventor: Anand Rau, Irvine, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/158,371

(22) Filed: Jun. 22, 2005

Related U.S. Application Data
(60) Provisional application No. 60/659,829, filed on Mar. 8, 2005.

(51) Int. Cl. G06Q 40/00

(52) U.S. Cl. 705/37

(57) ABSTRACT

An inter-enterprise supply chain management system uses programs to manage supply chain transaction data received from a plurality of trading partners. A program is defined using program definers including at least a first trading relation between a first and a second trading partner and a second trading relation between a third and a fourth trading partner. Other program definers may include a location, item, and/or taxonomy. The program identifies a subset of the supply chain transaction data that satisfies the program definition. Actions on the supply chain transaction data by the trading partners of the program are limited to only that subset of supply chain transaction data. The users of the trading partners of the program can additionally be associated with a security role limiting the types of actions the users can take on that subset of supply chain transaction data.

### CROSS-REFERENCE TO RELATED APPLICATION

This application claims priority under 35 U.S.C. §119(e) to co-pending U.S. Provisional Patent Application No. 60/659,829, entitled “Program-Based Supply Chain Management,” filed on Mar. 8, 2005, the subject matter of which is incorporated by reference herein in its entirety.

### BACKGROUND OF THE INVENTION

1. Field of the Invention

The present invention relates to supply chain management, and more specifically, to inter-enterprise supply chain management software that manages supply chain transaction data using programs.

2. Description of the Related Art

Outsourcing has become very popular in all sectors of the industry and especially in product manufacturing. Companies no longer manufacture and assemble all components of a product themselves, but outsource most or all parts of the development, manufacturing, distribution, and marketing of the product. For example, companies A and B may manufacture and sell parts to company C. Company C may assemble those parts and sell assembled modules of a product to company D. Company D may assemble such modules together with other components and modules obtained from other companies, and sell the final product to Company E. Company E may sell the product under its brand to a distributor Company F which sells the final product to a retailer company G, which eventually sells the final product to the end consumer.

Since most or all parts of the development, manufacturing, distribution, and marketing of the product are outsourced, no single company has control of all the supply chain transaction data and information relating to the overall development, manufacturing, distribution, and marketing of the product. Therefore, enterprise supply chain management software that manages the data relating to the role played by only one company in the process of development, manufacturing, distribution, and marketing of the product cannot effectively manage the entire outsourcing process.

Conventional inter-enterprise supply chain management software that manages supply chain transaction data in between the various companies involved in the process of development, manufacturing, distribution, and marketing of the product solves this problem. Such conventional inter-enterprise supply chain management software resides in a separate location apart from and between the various companies. The various companies involved in such process exchange data with the conventional inter-enterprise supply chain management software according to the format of their own enterprise supply chain management software, and are able to view or perform actions on certain supply chain management transaction data (e.g., placing an order, paying an invoice) using the conventional inter-enterprise supply chain management software. At the same time, such companies are able to obtain and monitor information on the entire process of development, manufacturing, distribution, and marketing of the product through the conventional inter-enterprise supply chain management software.

A problem of the conventional inter-enterprise supply chain management software is that there is no mechanism for a company or a user of the conventional inter-enterprise supply chain management to configure, in a convenient and efficient way, which company or user involved in the supply chain can view or perform actions. There is no mechanism for either a company or a user of the conventional inter-enterprise supply chain management to limit the access to or taking of actions on certain types of supply chain management transactions to a certain group of companies or users according to particular criteria.

Therefore, there is a need for a convenient mechanism to manage subsets of the supply chain transaction data according to defined criteria. There is also a need for a convenient mechanism to configure the privileges of a company or user involved in the supply chain management to view or perform actions on certain supply chain transaction data. There is also need for a convenient mechanism to configure such privileges by certain groups of companies or users within the groups.

### SUMMARY OF THE INVENTION

The present invention provides a method of managing supply chain transaction data, using a defined program, among a plurality of trading partners in an inter-enterprise supply chain management system. The inter-enterprise supply chain management system resides on a computer server separate from the trading partners' enterprise software, and receives the supply chain transaction data from the trading partners' enterprise software.

A program is defined using program definers. The program definers include at least a first trading relation and a second trading relation, where the first trading relation is between a first trading partner and a second trading partner and the second trading relation is between a third trading partner and a fourth trading partner. The first trading partner and the third trading partner can be identical to or different from each other.

The inter-enterprise supply chain management system uses the defined program to allow certain actions only on the supply chain transaction data satisfying the definition of the program, where such supply chain transaction data include at least the first trading relation or the second trading relation. In other words, the defined program is used to define a subset of the supply chain transaction data that satisfies the program definition, and actions on the supply chain transaction data by the trading partners included in the program are limited to only that subset of the supply chain transaction data that satisfies the program definition. These actions may include viewing the supply chain transaction data or performing other types of actions corresponding to selected ones of the supply chain transaction data.

Each of the trading partners can additionally be associated with a security role. The security role includes a set of privileges that limits the types of actions that the inter-enterprise supply chain management system allows the user of the associated trading partner to take on the supply chain transaction data.

The program can be further defined with additional program definers such as location, item, taxonomy, and the like. One or more of these program definers may be combined with the trading relations and/or the security roles to further define the program for the inter-enterprise supply chain management system.

For example, the program can be further defined by using the locations associated with the trading partners as an additional program definer, in which case the supply chain transaction data satisfying the program definition would also include the location in addition to the first trading relation or the second trading relation. The location may include a particular location name and/or a particular location type. The program can also be further defined by an item associated with the first trading partner, in which case the supply chain transaction data satisfying the program definition would also include the item in addition to the first trading relation or the second trading relation. In addition, the program can also be further defined by a taxonomy associated with the first trading partner. The taxonomy is a category of items organized in a hierarchical fashion, and the supply chain transaction data satisfying the program definition would include the selected taxonomy in addition to the first trading relation or the second trading relation.

The inter-enterprise supply chain management system of the present invention includes a convenient user interface that provides a template from which a variety of program definers can be selected or excluded to define the program. Once a program is defined, the supply chain transaction data satisfying the definition of the program would be displayed in the user interface in a color selected for that defined program; if the selected program is a different one, the supply chain transaction data would be displayed in the user interface with a different color.

By use of the program concept according to the inter-enterprise supply chain management system of the present invention, it is possible to create multiple programs with different program definitions, and manage the supply chain transaction data using a plurality of subsets of the supply chain transaction data where each subset satisfies the definition of the respective program. For example, a company (trading partner) may create two different programs defined by two different sets of program definers (e.g., trading partners) to manage the same supply chain transaction data in a different manner as defined by each of the two different programs. In one program the trading partner may allow access to a set of supply chain transaction data to a set of trading partners, while in the other program the trading partner may allow access to the same set of supply chain transaction data to a different set of trading partners. Therefore, the supply chain transaction data can be managed in a customized manner depending upon the needs of each of the trading partners creating and defining the programs, while all of the supply chain transaction data relating to all of the trading partners still reside in the same inter-enterprise supply chain management system.

### BRIEF DESCRIPTION OF THE DRAWINGS

The teachings of the present invention can be readily understood by considering the following detailed description in conjunction with the accompanying drawings. Like reference numerals are used for like elements in the accompanying drawings.

FIG. 1 illustrates the interaction of the inter-enterprise supply chain management (SCM) software with various trading partners, according to one embodiment of the present invention.

FIG. 2 is a block diagram of the simplified software architecture of the inter-enterprise supply chain management software, according to one embodiment of the present invention.

FIG. 3 is a flow chart illustrating a method of defining a program in the inter-enterprise supply chain management software, according to one embodiment of the present invention.

FIG. 4 is a flow chart illustrating a method of using the defined program in the inter-enterprise supply chain management software to limit the actions on supply chain transaction data by certain trading partners of the program and the privileges assigned to the users of the program, according to one embodiment of the present invention.

FIG. 5 is a block diagram illustrating the hardware architecture of an inter-enterprise supply chain management system, according to one embodiment of the present invention.

FIG. 6 is a screen shot of a user interface for creating a new program, according to one embodiment of the present invention.

FIG. 7 is a screen shot of a user interface for selecting certain trading partners as one of the program definers for the new program, according to one embodiment of the present invention.

FIG. 8 is a screen shot of a user interface for selecting certain locations as one of the program definers for the new program, according to one embodiment of the present invention.

FIG. 9 is a screen shot of a user interface for selecting certain items as one of the program definers for the new program, according to one embodiment of the present invention.

FIG. 10 is a screen shot of a user interface for selecting certain taxonomies as one of the program definers for the new program, according to one embodiment of the present invention.

FIG. 11 is a screen shot of a user interface for assigning users to the new program, according to one embodiment of the present invention.

FIG. 12 is a screen shot of a user interface for viewing supply chain transaction data with no program selected, according to one embodiment of the present invention.

FIG. 13 is a screen shot of a user interface for viewing supply chain transaction data with a program selected, according to one embodiment of the present invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF EMBODIMENTS

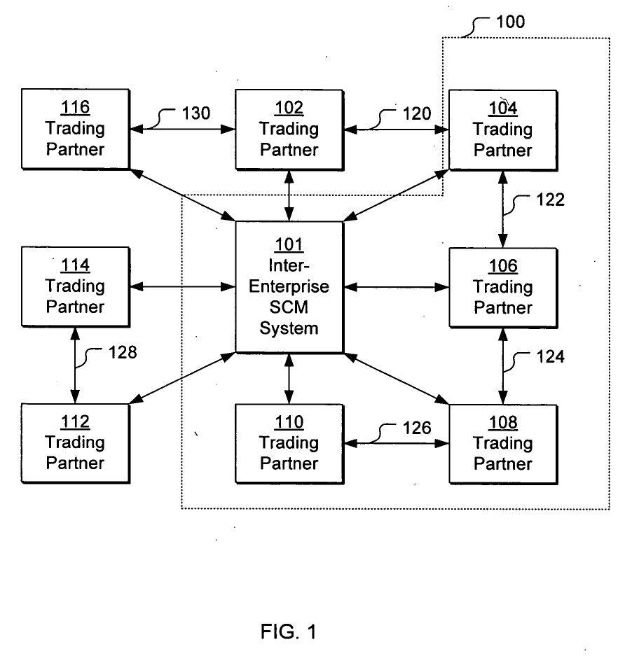

FIG. 1 illustrates the interaction of the inter-enterprise supply chain management (SCM) system 101 with various trading partners. A number of trading partners (typically, companies or other types of entities involved in the supply chain) 102, 104, 106, 108, 110, 112, 114, 116 in the supply chain interact with one another in the process of developing, manufacturing, marketing and selling one or more products. A number of trading relations 120, 122, 124, 126, 128, and 130 exist, where each trading relation involves two trading partners. For example, the trading relation 122 involves two trading partners 104, 106.

Each of these trading partners 102, 104, 106, 108, 110, 112, 114, 116 maintains its own enterprise supply chain management software for managing its own supply chain transaction data. Such supply chain transaction data may include computer data representative of a number of transactions in the supply chain, such as placing a purchase order (PO), billing, shipping a product, remitting a payment, etc. Such supply chain transaction data are maintained such that each trading partner may monitor the progress of its own role in the supply chain.

However, without information from other trading partners involved in the supply chain, it is not possible for one trading partner to completely monitor the progress of even its own role in the supply chain. For example, one trading partner 108 may be waiting for parts to arrive from another trading partner 110, but would not know whether such parts were shipped from the trading partner 110 unless trading partner 110 makes such information available to trading partner 108.

Therefore, each of these trading partners also exchange such supply chain transaction data through the inter-enterprise supply chain management system 101 so that the data becomes available to other trading partners involved in the supply chain. By using the inter-enterprise supply chain management system 101, a trading partner 104 may monitor the progress of the functions provided by other trading partners, e.g., trading partners 106, 108, in the supply chain, although the trading partners do not exchange such data directly with one another.

In certain situations, companies want to define a group of selected trading partners and their users among the trading partners 102, 104, 106, 108, 110, 112, 114, 116 so that viewing and performing other actions on the supply chain transaction data among the selected trading partners is limited to such selected trading partners and their users. Such group is called a “program” herein.

Programs typically include at least two trading relations. Each trading relation typically involves two trading partners. These trading partners may overlap with each other or may all be distinct trading partners. In addition, “company roles” (buyer, seller, and the like) are associated with the trading partners. It is possible to define a trading relation by associating a company role with only one of the two trading partners in the trading relation because the company role of the other one of the two trading partners can be readily determined to be the opposite company role (e.g., if one trading partner is a buyer, the other trading partner is a seller). For example, a program 100 may be defined such that it includes the trading relations 122, 124, and 126. The trading relation 122 involves the trading partners 104, 106, the trading relation 124 involves the trading partners 106, 108, and the trading relation 126 involves the trading partners 108, 110. In the trading relation 122, the trading partner 104 may be associated with a “buyer” company role, which means that the other trading partner 106 in the trading relation 122 is a “seller” although such “seller” company role need not be explicitly assigned when defining the program (obviously, the “seller” company role can be explicitly assigned as well).

Once a program is defined, only transaction information (supply chain transaction data) belonging to the defined program can be viewed or otherwise acted on by the trading partners (and their users) in the program. Other transaction information outside the scope of the defined program is inaccessible and becomes irrelevant to the trading partners in the defined program. Furthermore, privileges (which define a security role) can be assigned to the users of each trading partner 102, 104, 106, 108, 110, 112, 114, 116 of the program such that the users of each trading partner 102, 104, 106, 108, 110, 112, 114, 116 can perform certain actions to the supply chain transaction data among the trading partners 102, 104, 106, 108, 110, 112, 114, 116 only according to the privileges. For example, the program 100 may be one set up by the trading partner 104. When the trading partner 104 sets up the program 100, trading partner 104 can assign privileges such that its own users within the trading partner 104 may view and perform all other actions (e.g., making payments, making purchase orders) on the transactions but that other users of the trading partners 106, 108, and 110 may only view the transactions with no privilege to perform other actions on the transactions. The set of privileges assigned to the users of a trading partner is also referred to herein as a “security role.”

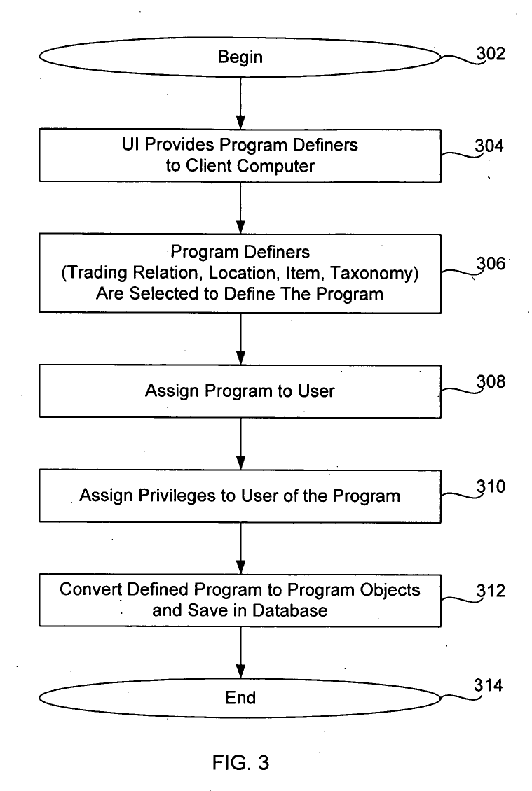

Therefore, a program is defined with at least two trading relations involving their associated trading partners. The program may be further defined with the privileges assigned to the users of the associated trading partners, and also with other elements such as location, taxonomy, items, and assigned user. Defining a program according to the present invention is explained in more detail with reference to FIG. 3.

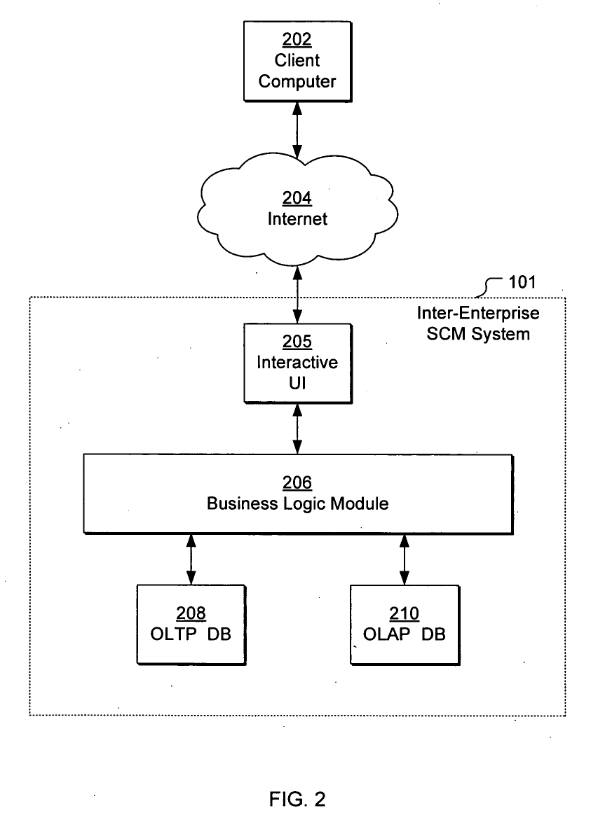

FIG. 2 is a block diagram of the simplified software architecture of the inter-enterprise supply chain management system 101 according to one embodiment of the present invention. The client computers 202 of the users of the trading partners interact and communicate with the inter-enterprise supply chain management (SCM) system 101 through the Internet 204 by state of the art Internet communications protocols, such as TCP/IP. The interactive user interface (UI) module 205 provides the interface for the users of the client computers 202 to communicate with the inter-enterprise supply chain management (SCM) system 101. The user interface 205 provides a configurable template from which the users of the client computers 202 can select certain elements defining a program (“program definers”) such as trading partners, items, locations, taxonomy, and assigned users and the privileges associated with the users, to define programs according to the present invention.

The business logic module 206 includes the computer instructions for setting up a program according to the program definition received through the interactive user interface 205 and for processing the supply chain transaction data based on the defined program. The business logic module 206 receives the defined program definition and stores it in the on-line transaction processing (OLTP) database 208. The business logic module 206 also stores other raw supply chain transaction data in the OLTP database 208 and modified supply chain transaction data (with business intelligence) in the on-line analytical processing (OLAP) database 210.

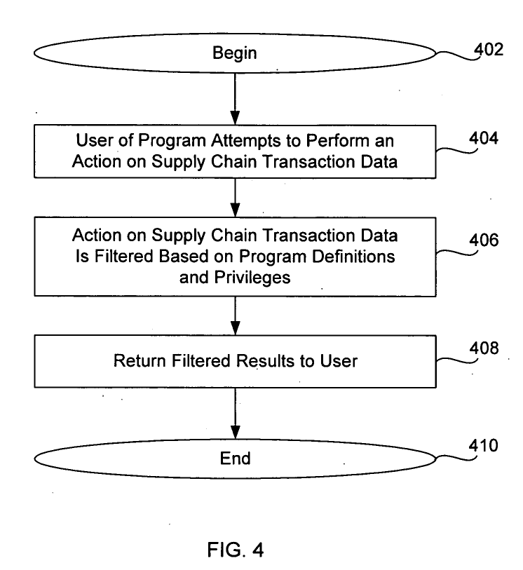

When the user of the client computer 202 requests the inter-enterprise SCM system 101 to perform a certain action on supply chain transaction data (e.g., viewing certain transaction data between trading partners, making a purchase order from one trading partner to another trading partner), such request can be associated with a program used for the request. The business logic module 206 receives such request through the interactive UI 205 and processes it according to the associated program definitions (retrieved from the OLTP DB 208). In other words, the business logic module 206 allows or disallows and processes certain actions on the supply chain transaction data in the request depending upon the various elements defining the associated program, as will be explained in more detail with reference to FIG. 4.

FIG. 3 is a flow chart illustrating a method of defining a program in the inter-enterprise supply chain management system, according to one embodiment of the present invention. The program can be set up to manage supply chain transaction data relating to a number of types of transactions in the supply chain, such as purchase orders (blanket purchase orders, consignment purchase orders, transfer purchase orders, proxy purchase orders, and the like), forecasts, invoices (payment, receipt), inventory transactions (inventory transfer, inventory counts, inventory adjustments), and the like. Note that the supply chain management system of the present invention is not limited to particular types of transactions.

A user of the client computer 202 interacts with the inter-enterprise SCM system 101 to define a program to be owned by the user's company (trading partner). As the process begins 302, the interactive UI module 205 provides 304 the client computer 202 with a configurable user interface with various elements (also referred to herein as “program definers”) for defining a program. The user interface is preferably set up in such a way that the user may select or unselect 306 certain elements defining the program from a template. The users typically associate the program with a program name and select the program definers from the template to set up the program. The program definers include at least two trading relations, location, item, taxonomy, users, privileges of the users, and the like.

Each trading relation typically involves two trading partners. As stated previously, these trading partners may overlap with each other or may all be distinct trading partners, and “company roles” (buyer, seller, and the like) are associated with the trading partners. Other company roles may include third party, manufacturer, vendor, and the like. The user will select the trading partners that constitute the program and assign “company roles” to the trading partners so that at least two trading relations are established within the program. For example, the user may name the program “ABC” and may select trading partner A, as a buyer, with trading partner B (implicitly, a seller) to define a first trading relation and select trading partner A, as a seller, with trading partner C (implicitly, a buyer) to define a second trading relation. By defining the program with the first and second trading relations including trading partners A, B, and C, only supply chain transaction data associated with (owned by) the trading partners A, B, and C will be included for actions in this program ABC.

“Location” refers to the actual locations where the transactions associated with these selected trading partners A, B, or C occur. These locations may be certain places that belong to the trading partner A, B, or C, such as a particular warehouse or a particular address of the trading partner. For example, locations for purchase order transactions may be associated with locations such as a “ship from” location, “ship to” location, “bill to” location, or “remit to” location. Invoice transactions may be associated with locations such as a “bill to” location or a “remit to” location, and the like. Each selected location is associated with a particular type of transaction which is in turn associated with a particular trading partner that owns such transaction. By defining a program with certain selected locations, only transactions associated with those selected locations will be included for actions in the program.

“Item” refers to the identification of the product that is being traded in a supply chain transaction. For example, the items can be included in the program as a product number, model number, serial number, and the like. Each selected item is associated with a particular trading partner that owns the transaction for trading such item. By defining the program with certain selected items, only transactions associated with those selected items will be included for actions in this program.

“Taxonomy” refers to the classification of the items that are being traded. In one embodiment, the taxonomy is organized in a hierarchical manner such that each taxonomy corresponds to a node in a hierarchical tree structure. The hierarchy may be organized based on manufacturer, geographical application, and the like. For example, one taxonomy may include cellular telephones, which in turn include cellular telephones manufactured by company A and cellular telephones manufactured by company B. Cellular telephones manufactured by company A may in turn include cellular telephones manufactured by company A for sale in the U.S. and cellular telephones manufactured by company A for sale in Europe. Each selected taxonomy is associated with a particular trading partner that owns the transaction involving such taxonomy. By defining the program with the certain selected taxonomies, only transactions associated with those selected taxonomies will be included for actions in this program.

Then, the program is assigned 308 to one or more users of the company that owns the defined program. In addition, certain privileges are assigned 310 to each user of the defined program. The privileges may include, for example, to view certain supply chain transaction data in the program or take other actions (make purchase order, pay invoice, etc.) on certain supply chain transaction data in the program. Each assigned user of the program may have different privileges. The privileges may be defined in terms of the actions that can be taken on the supply chain transaction data by a specific user. Then, the defined program is converted 312 to program objects and saved in the OLTP DB 208 and the process ends 314.

FIG. 4 is a flow chart illustrating a method of using the defined program in the inter-enterprise supply chain management system to limit the actions on supply chain transaction data to certain trading partners of the program and by the privileges assigned to the users of the program, according to one embodiment of the present invention. As the process begins 402, a user of a program accesses the inter-enterprise SCM system 101 and attempts 404 to perform certain actions on the supply chain transaction data. These actions may include viewing the transaction data or performing other actions on the transaction data (e.g., causing a transaction corresponding to the data to occur). The inter-enterprise SCM system 101 filters 406 the supply chain transaction data and allows or disallows the attempted action on the supply chain transaction data according to the program definers and the privileges assigned to the user. In other words, the inter-enterprise SCM system 101 determines whether the particular supply chain transaction data belong to the program based on the program definers such as the trading partner, item, location, and taxonomy. If the particular supply chain transaction data is part of the program, then the inter-enterprise SCM system 101 further allows or disallows the attempted action on the supply chain transaction data based on the privileges assigned to the user of the program. For example, if the user only has viewing privileges but attempts to make a purchase order, such action will be disallowed. The filtered results of the actions on the transaction are returned 408 to the user and the process ends 410.

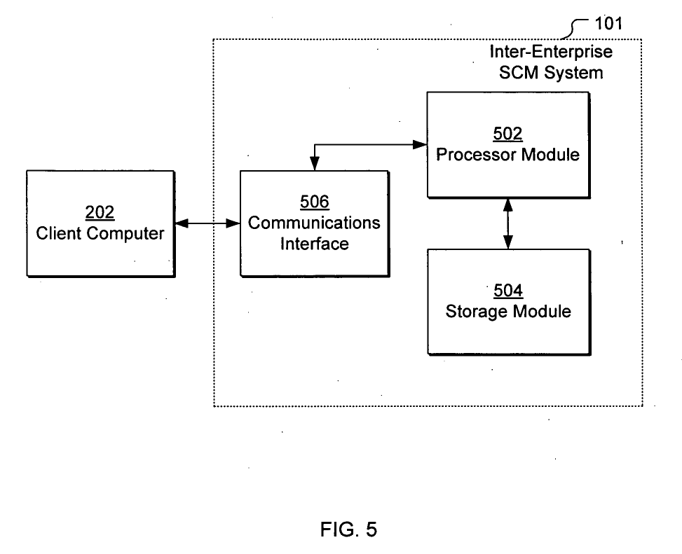

FIG. 5 is a block diagram illustrating the hardware architecture of an inter-enterprise supply chain management system 101, according to one embodiment of the present invention. The inter-enterprise supply chain management system 101 includes a storage module 504, a processor module 502, and a communications interface 506.

The storage module 504 stores the inter-enterprise supply chain management system software as illustrated herein, including the computer instructions for implementing the interactive UI 205 and the business logic module 206, as well as the supply chain transaction data stored in the OLTP DB 208 and the OLAP DB 210. Such inter-enterprise supply chain management system software may be stored as a computer program product on a separate computer readable medium or on a storage device such as the storage module 504 within the computer for the inter-enterprise supply chain management system 101. The inter-enterprise supply chain management system software can also be part of larger software. The storage module 504 can be any type of computer-readable storage medium.

The processor module 502 is coupled to the storage module 504 and the communications interface 506, and is configured to execute the computer instructions of the inter-enterprise supply chain management system software stored in the storage module 504. The processor module 502 can be any type of computer processor. The communications interface 506 provides the inter-enterprise SCM system 101 with communication capabilities with the client computer 202, and can be any type of wired or wireless communication interface.

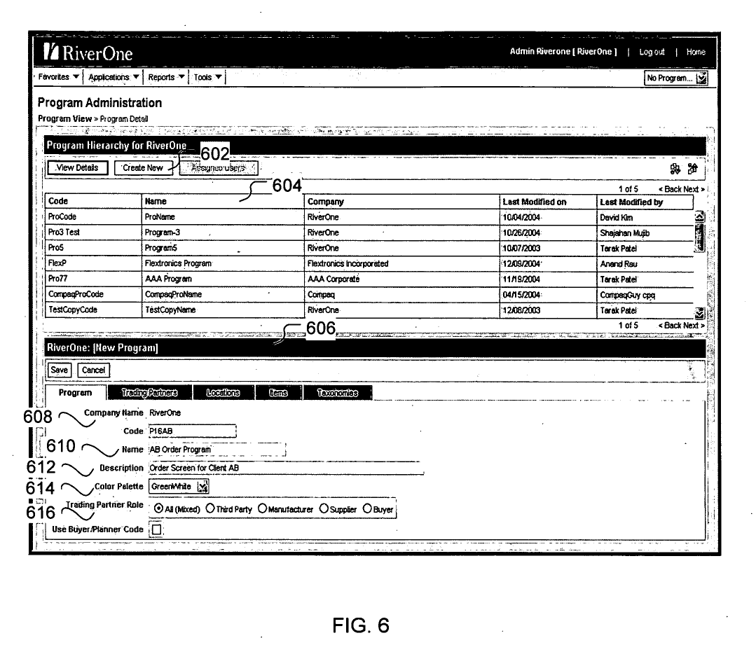

FIG. 6 is a screen shot of a user interface for creating a new program, according to one embodiment of the present invention. The list 604 shows the programs already existing in the inter-enterprise SCM system 101. One may create and define a new program for the inter-enterprise SCM system 101 by clicking the “create new” button 602, which causes the template 606 to launch. The template 606 enables setting up the program by adding a program name 610 (e.g., AB Order Program), a company name (trading partner) 608 that will own the newly created program, a description 612 of the newly created program, a color palette 614 to be used for all user interfaces relating to the newly created program, and the company role 616 associated with the trading partner 608. The company roles may include a third party role, a manufacturer role, a supplier role, a buyer role, or all of these roles. Here, the company name 608 is “RiverOne” and is associated with a trading partner role (company role) 616 of “all.”

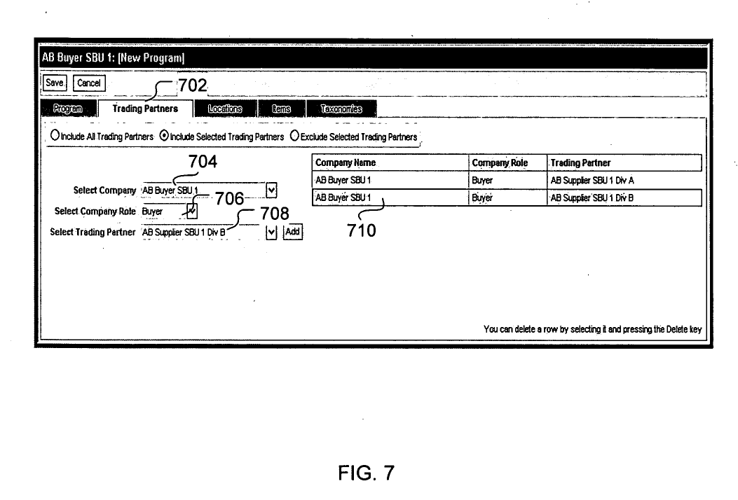

FIG. 7 is a screen shot of a user interface for selecting certain trading partners as one of the program definers for the new program, according to one embodiment of the present invention. The template shown in FIG. 7 allows one to define a program by selecting or excluding certain trading partners or including all trading partners in the program to be created. One clicks on the “trading partners” tab 702 to define the program with the trading partners as the program definer. One can select a company (trading partner) 704 (e.g., AB Buyer SBU 1) as a trading partner that belongs to the program to be created, assign a company role (e.g., buyer) 706 of the selected company and select the counterpart trading partner (e.g., AB supplier SBU 1 Div B) 708 to complete one trading relation. Although the company role of the trading partner (e.g., AB supplier SBU 1 Div B) 708 is not assigned explicitly, it is assigned implicitly as the counterpart (seller or supplier) of the company role (buyer) 706 assigned to the company (AB Buyer SBU 1) 704.

The list 710 shows the trading relations that define this program. The first trading relation includes trading partner AB Buyer SBU 1 as a buyer with the counterpart trading partner AB Supplier SBU1 Div A (implicitly as a supplier). The second trading relation includes trading partner AB Buyer SBU 1 as a buyer with the counterpart trading partner AB Supplier SBU1 Div B (implicitly as a supplier). By defining the program with these two trading relations, all supply chain transaction data belonging to these two trade relations will be included in this program to be created and users of the program will be able to view or otherwise perform actions on those supply chain transaction data according to the security roles (privileges) assigned to their companies and to the users within their companies. Note that a program should include at least two trading relations to be defined meaningfully; if there were only one trading relation, a program based inter-enterprise SCM system would not be necessary.

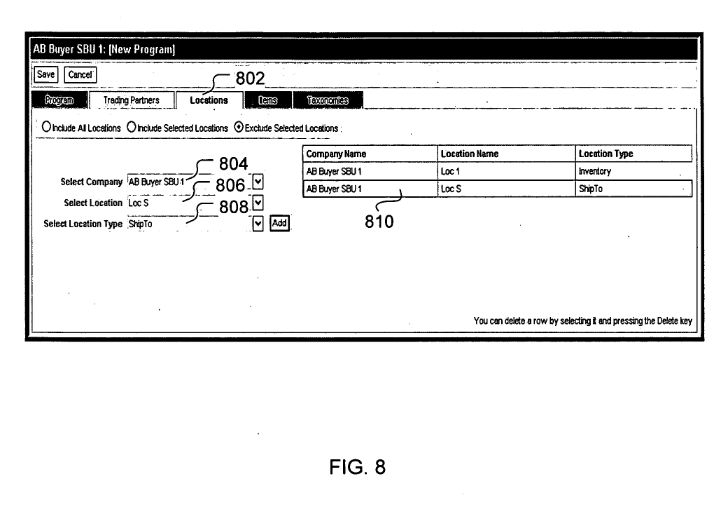

FIG. 8 is a screen shot of a user interface for selecting certain locations as one of the program definers for the new program, according to one embodiment of the present invention. The template shown in FIG. 8 allows one to define a program by selecting or excluding certain locations or including all locations in the program to be created. One clicks on the “Locations” tab 802 to define the program with the locations as the program definer. As stated previously, each location is associated with a company (trading partner). Therefore, one can select a company (trading partner) 804 (e.g., AB Buyer SBU 1) as the owner of the location to be selected, which will cause the user interface to display the location names 806 associated with the selected company 804. The location name 806 is selected to define the program. One location may also be associated with various functions, i.e., a location type; for example, the same location Loc S 806 may be a “ship to” location or a “ship from” location. Thus, the location type 808 is also selected in addition to the location name 806 to further define the program.

The list 810 shows the locations that define this program. The first location is Loc 1 associated with the company (AB Buyer SBU 1) functioning as an “inventory” location type. The second location is Loc S associated with the company (AB Buyer SBU 1) functioning as a “ShipTo” location type. By defining the program with these two locations, all supply chain transaction data including these two locations will be included in the program to be created, and users of the program will be able to view or otherwise perform actions on those supply chain transaction data according to the security roles (privileges) assigned to their companies and to the users within their companies. However, supply chain transaction data that do not include such locations will not be included in the program to be defined.

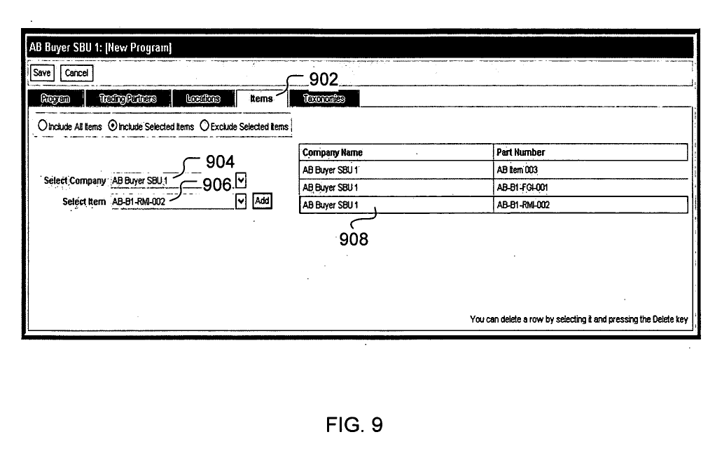

FIG. 9 is a screen shot of a user interface for selecting certain items as one of the program definers for the new program, according to one embodiment of the present invention. The template shown in FIG. 9 allows one to define a program by selecting or excluding certain items or including all items in the program to be created. One clicks on the “Items” tab 902 to define the program with the items as the program definer. As stated previously, each item is associated with a company (trading partner). Therefore, one can select a company (trading partner) 904 (e.g., AB Buyer SBU 1) as the owner of the item to be selected, which will cause the user interface to display the items 906 traded by the selected company. The item 906 is selected to define the program.

The list 908 shows the items that define this program. The first item is “AB Item 003” associated with the company (AB Buyer SBU 1) 904. The second item is “AB-B1-FGI-001” associated with the company (AB Buyer SBU 1) 904. The third item is “AB-B1-RMI-002” associated with the company (AB Buyer SBU 1) 904. By defining the program with these three items, all supply chain transaction data including these three items will be included in this program to be created, and users of the program will be able to view or otherwise perform actions on those supply chain transaction data according to the security roles (privileges) assigned to their companies and to the users within their companies. However, supply chain transaction data that do not include such items will not be included in the program to be defined.

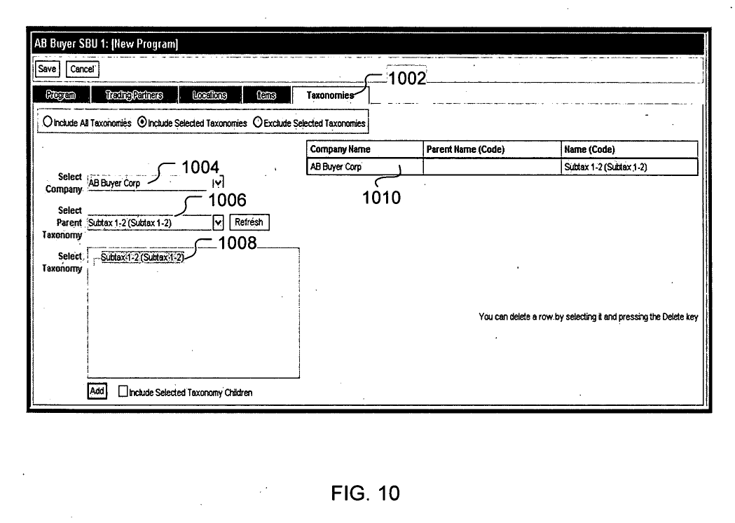

FIG. 10 is a screen shot of a user interface for selecting certain taxonomies as one of the program definers for the new program, according to one embodiment of the present invention. The template shown in FIG. 10 allows one to define a program by selecting or excluding certain taxonomies or including all taxonomies in the program to be created. One clicks on the “Taxonomies” tab 1002 to define the program with the taxonomies as the program definer. As stated previously, each taxonomy is associated with a company (trading partner). Therefore, one can select a company (trading partner) 1004 (e.g., AB Buyer Corp) as the owner of the taxonomy to be selected, which will cause the user interface to display the parent taxonomy 1006 and child taxonomy 1008 associated with the selected company 1004. As explained above, taxonomies are organized in a hierarchical manner such that each taxonomy corresponds to a node in a hierarchical tree structure. Here, the user selects Subtax 1-2 as the parent taxonomy 1006 and the selected taxonomy 1008 to define the program, because Subtax 1-2 does not have any child taxonomy.

The list 1010 shows the taxonomies that define this program. The selected taxonomy is Subtax 1-2 owned by the company AB Buyer Corp 1004. By defining the program with this taxonomy, all supply chain transaction data including this taxonomy (within the classification of this taxonomy) will be included in this program to be created, and users of the program will be able to view or otherwise perform actions on those supply chain transaction data according to the security roles (privileges) assigned to their companies and to the users within their companies. However, supply chain transaction data that do not include such taxonomy will not be included in the program to be defined.

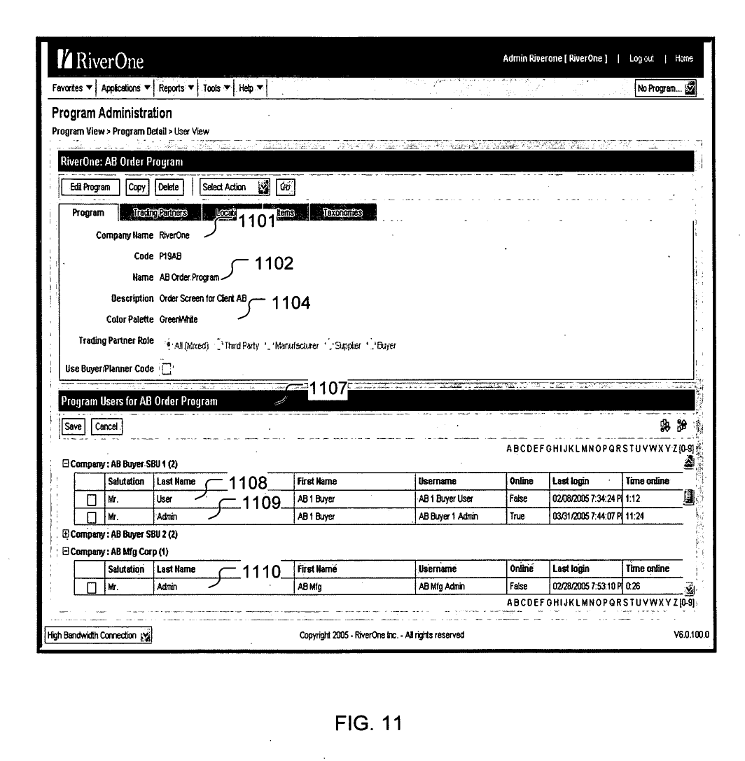

FIG. 11 is a screen shot of a user interface for assigning users for the new program, according to one embodiment of the present invention. Once a program is created for a company (here, the AB Order Program 1102 for the company RiverOne 1101), one or more users may be assigned to the created program. The user list 1107 displays the users to select for the AB Order Program 1102. These users belong to the trading partners (companies) that form the trading relations defining the AB Order Program 1102. For example, the user list 1107 shows three trading partners, AB Buyer SBU 1, AB Buyer SBU 2, and AB Mfg Corp, that form the trading relations defining the AB Order Program 1102. Each trading partner includes one or more users; for example, AB Buyer SBU 1 includes two users, AB 1 Buyer User 1108 and AB Buyer 1 Admin 1109, and AB Mfg. Corp includes one user, AB Mfg Admin 1110. These users may be selected or unselected simply by checking or unchecking the boxes next to the user names to assign or unassign the users to the AB Order Program.

The users will assume the security roles (set of privileges) corresponding to the company roles of their respective companies. Also note that the user interface showing the selected program (AB Order Program) 1102 will be displayed in the color (GreenWhite) selected by the color palette 1104 for the program (AB Order Program) 1102. Supply chain transaction data belonging to different programs are displayed in different colors according to the color palette selected when the associated programs are created.

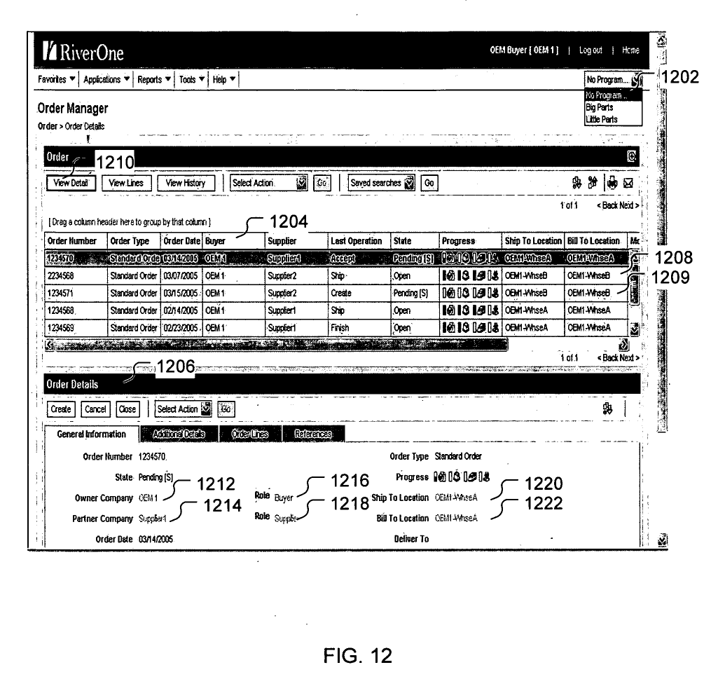

FIG. 12 is a screen shot of a user interface for viewing certain supply chain transaction data with no program selected, according to one embodiment of the present invention. The user interface shown in FIG. 12 is for viewing the supply chain transaction data as listed in the transaction list 1204. When “No Program” 1202 is selected, the inter-enterprise SCM system 101 will show all transactions regardless of the program definitions. Here, five supply chain transactions with order numbers 1234570, 2234568, 1234571, 1234568, and 1234569 are shown in the transaction list 1204. There may be additional transactions not shown on the list 1204 due to the small window size. Note that the transaction 1208 with order number 2234558 and the transaction 1209 with order number 1234571 between the trading partners OEM 1 and Supplier2 are shown in the transaction list 1204.

The lower half of the user interface shows the detailed supply chain transaction data 1206 corresponding to the transaction selected in the transaction list 1204. In FIG. 12, the detailed data 1206 of the transaction with order number 1234570 is shown, with two trading partners OEM 1 1212 (owner company of the transaction having Buyer role 1216) and Supplier1 1214 (partner company of the transaction having Supplier role 1218) being the trading partners involved in this order transaction. Also note that this order transaction has two locations involved, a ShipTo location (OEM-WhseA) 1220 and a BillTo Location (OEM1-WhseA) 1222 both owned by the owner company (OEM1) 1212.

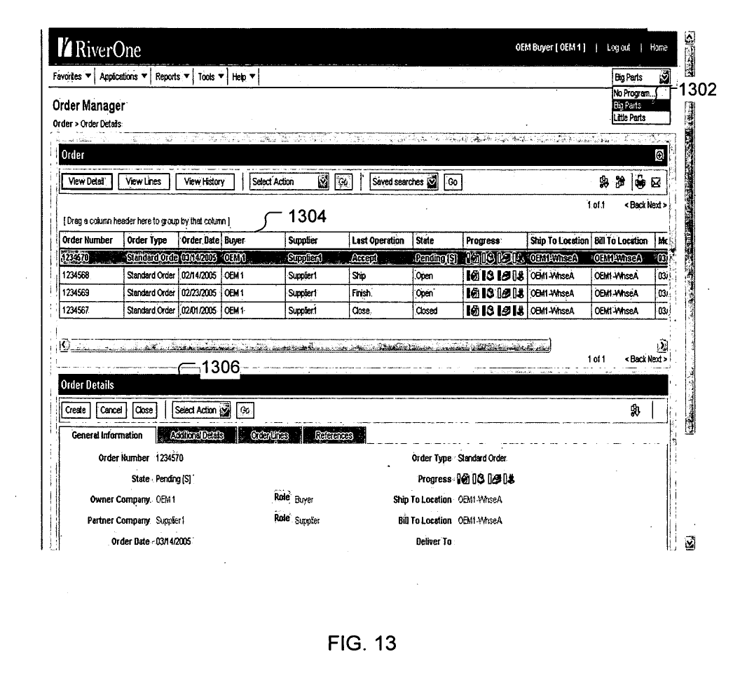

FIG. 13 is a screen shot of a user interface for viewing certain supply chain transaction data with a program selected, according to one embodiment of the present invention. When a program is selected, the inter-enterprise SCM system 101 will show only transactions belonging to the selected program (i.e., transactions satisfying the definition of the selected program), and also according to the privileges associated with the user of the owner company of the selected program. Note that the program can be defined by one or more trading relations including trading partners, locations, items, taxonomies, privileges, and the like.

Here, the program “Big Parts” 1302 is selected, and only four supply chain transactions with order numbers 1234570, 1234568, 1234569, and 1234567 are shown in the transaction list 1304. Note that the transactions with order numbers 2234558 and 1234571 between the trading partners OEM 1 and Supplier2, which are included in the view of FIG. 12, are not shown in the transaction list 1304. This is because the “Big Parts” program is defined in a way not to include transactions between the trading partners OEM 1 and Supplier2. Only transactions 1234570, 1234568, 1234569, and 1234567 between the trading partners OEM1 and Supplier1 are shown in FIG. 13, because the “BigParts” program is defined with only the trading partners, OEM1 and Supplier1, selected as the program definers.

Although the present invention has been described above with respect to several embodiments, various modifications can be made within the scope of the present invention. For example, the program definers are not limited to those described herein, and can include other program definers that may be useful for managing supply chain transaction. The type of actions performed on the supply chain transaction data are not limited to the actions illustrated herein; any other types of actions may be used with the defined program of the present invention. Moreover, the types of supply chain transactions are not limited to those described herein; any other types of supply chain transactions may be used with the defined programs according to the present invention. Accordingly, the disclosure of the present invention is intended to be illustrative, but not limiting, of the scope of the invention, which is set forth in the following claims.

What is claimed is:

1. A computer-implemented method of managing supply chain transaction data among a plurality of trading partners in an inter-enterprise supply chain management system receiving the supply chain transaction data from the plurality of trading partners, the method comprising:
receiving a definition of a program including at least a first trading relation and a second trading relation, the first trading relation being between a first trading partner and a second trading partner and the second trading relation being between a third trading partner and a fourth trading partner; and
allowing actions only on part of the supply chain transactions data satisfying the definition of the program, the part of the supply chain transaction data including at least the first trading relation or the second trading relation.

2. The computer-implemented method of claim 1, wherein the first trading partner and the third trading partner are identical to each other.

3. The computer-implemented method of claim 1, wherein the program is further defined by a security role, the security role including a set of privileges limiting types of the actions allowed on the part of the supply chain transaction data for a user of the first trading partner.

4. The computer-implemented method of claim 1, wherein the program is further defined by a location associated with the first trading partner and the part of the supply chain transaction data satisfying the definition of the program include the location in addition to the first trading relation or the second trading relation.

5. The computer-implemented method of claim 4, wherein the location includes a location name and allocation type.

6. The computer-implemented method of claim 1, wherein the program is further defined by an item associated with the first trading partner and the part of the supply chain transaction data satisfying the definition of the program include the item in addition to the first trading relation or the second trading relation.

7. The computer-implemented method of claim 1, wherein the program is further defined by a taxonomy associated with the first trading partner, the taxonomy being a category of items, and the part of the supply chain transaction data satisfying the definition of the program include the taxonomy in addition to the first trading relation or the second trading relation.

8. The computer-implemented method of claim 1, further comprising providing a user interface for allowing the actions on the part of the supply chain transactions data, the user interface being displayed on a display device in a color selected for the program.

9. The computer-implemented method of claim 1, wherein the actions include viewing the supply chain transaction data.

10. The computer-implemented method of claim 1, wherein the actions include causing a transaction corresponding to a selected one of the supply chain transaction data to be performed.

11. The computer-implemented method of claim 1, wherein the definition of the program is received by selection of program definers in a template including the program definers in a user interface.

12. A computer readable medium storing a computer program product configured to perform a computer-implemented method of managing supply chain transaction data among a plurality of trading partners in an inter-enterprise supply chain management system receiving the supply chain transaction data from the plurality of trading partners, the method comprising:
receiving a definition of a program including at least a first trading relation and a second trading relation, the first trading relation being between a first trading partner and a second trading partner and the second trading relation being between a third trading partner and a fourth trading partner; and
allowing actions only on part of the supply chain transactions data satisfying the definition of the program, the part of the supply chain transaction data including at least the first trading relation or the second trading relation.

13. The computer readable medium of claim 12, wherein the first trading partner and the third trading partner are identical to each other.

14. The computer readable medium of claim 12, wherein the program is further defined by a security role, the security role including a set of privileges limiting types of the actions allowed on the part of the supply chain transaction data for a user of the first trading partner.

15. The computer readable medium of claim 12, wherein the program is further defined by a location associated with the first trading partner and the part of the supply chain transaction data satisfying the definition of the program include the location in addition to the first trading relation or the second trading relation.

16. The computer readable medium of claim 15, wherein the location includes a location name and a location type.

17. The computer readable medium of claim 12, wherein the program is further defined by an item associated with the first trading partner and the part of the supply chain transaction data satisfying the definition of the program include the item in addition to the first trading relation or the second trading relation.

18. The computer readable medium of claim 12, wherein the program is further defined by a taxonomy associated with the first trading partner, the taxonomy being a category of items, and the part of the supply chain transaction data satisfying the definition of the program include the taxonomy in addition to the first trading relation or the second trading relation.

19. The computer readable medium of claim 12, wherein the method further comprises providing a user interface for allowing actions on the part of the supply chain transactions data, the user interface being displayed on a display device in a color selected for the program.

20. The computer readable medium of claim 12, wherein the actions include viewing the supply chain transaction data.

21. The computer readable medium of claim 12, wherein the actions include causing a transaction corresponding to a selected one of the supply chain transaction data to be performed.

22. The computer readable medium of claim 12, wherein the definition of the program is received by selection of program definers in a template including the program definers in a user interface.

23. An inter-enterprise supply chain management system comprising:
a storage module storing computer instructions configured to cause the inter-enterprise supply chain management system to perform a computer-implemented method of managing supply chain transaction data received from a plurality of trading partners, the method comprising the steps of:
receiving a definition of a program including at least a first trading relation and a second trading relation, the first trading relation being between a first trading partner and a second trading partner and the second trading relation being between a third trading partner and a fourth trading partner; and
allowing actions only on part of the supply chain transactions data satisfying the definition of the program, the part of the supply chain transaction data including at least the first trading relation or the second trading relation; and
a processor module for executing the computer instructions.

24. The inter-enterprise supply chain management system of claim 23, wherein the first trading partner and the third trading partner are identical to each other.

25. The inter-enterprise supply chain management system of claim 23, wherein the program is further defined by a security role, the security role including a set of privileges limiting types of the actions allowed on the part of the supply chain transaction data for a user of the first trading partner.

26. The inter-enterprise supply chain management system of claim 23, wherein the program is further defined by a location associated with the first trading partner and the part of the supply chain transaction data satisfying the definition of the program include the location in addition to the first trading relation or the second trading relation.

27. The inter-enterprise supply chain management system of claim 26, wherein the location includes a location name and a location type.

28. The inter-enterprise supply chain management system of claim 23, wherein the program is further defined by an item associated with the first trading partner and the part of the supply chain transaction data satisfying the definition of the program include the item in addition to the first trading relation or the second trading relation.

29. The inter-enterprise supply chain management system of claim 23, wherein the program is further defined by a taxonomy associated with the first trading partner, the taxonomy being a category of items, and the part of the supply chain transaction data satisfying the definition of the program include the taxonomy in addition to the first trading relation or the second trading relation.

30. The inter-enterprise supply chain management system of claim 23, wherein the method further comprises providing a user interface for allowing actions on the part of the supply chain transactions data, the user interface being displayed on a display device in a color selected for the program.

31. The inter-enterprise supply chain management system of claim 23, wherein the actions include viewing the supply chain transaction data.

32. The inter-enterprise supply chain management system of claim 23, wherein the actions include causing a transaction corresponding to a selected one of the supply chain transaction data to be performed.

33. The inter-enterprise supply chain management system of claim 23, wherein the definition of the program is received by selection of program definers in a template including the program definers in a user interface.
